(19) United States
(12) Patent Application Publication
(10) Pub. No.: US 2005/0244162 A1
(43) Pub. Date: Nov. 3, 2005

(54) All-optical signal regeneration

(76) Inventors: Alan F. Evans, Beaver Dams, NY (US); Dmitri V. Kuksenkov, Painted Post, NY (US)

Correspondence Address: CORNING INCORPORATED, SP-TI-3-1, CORNING, NY, 14831, US

(21) Appl. No.: 10/837,854

(22) Filed: May 3, 2004

(51) Int. Cl. H04J 14/02; H04J 14/08

(52) U.S. Cl. 398/98

(57) ABSTRACT

An all-optical method of regenerating an optical return-to-zero format pulse signal of a first wavelength starts by introducing the input signal into a first end of a non-linear optical fiber to obtain a modified signal comprising pulses broadened in the wavelength domain. When this modified signal emerges from the second end of said non-linear optical fiber, a bandwidth slice is selected that is centered on a second wavelength so spaced from the first wavelength that its intensity is substantially unresponsive to weak pulses in the signal and relatively insensitive to intensity for other pulses. This slice is returned to the same non-linear optical fiber at its second end so that a further modified signal comprising pulses broadened in the wavelength domain will emerge from its first end. From this further modified signal a bandwidth slice centered on the first wavelength is selected as regenerated output. Regenerators operating in this way are also disclosed.

### BACKGROUND OF THE INVENTION

1. Field of the Invention

The present invention relates generally to optical communications technology, and particularly to the regeneration of optical signals in return-to-zero pulse formats.

2. Technical Background

Optical pulse signals are liable to degradation as a result of undesirable reflections, chromatic and polarization dispersion, self-phase and cross-phase modulation and other causes, and if bit errors are to be avoided on long routes, need not only to be amplified but also to be regenerated either to restore the original pulse format or to change to another satisfactory format. This can be done by detecting the pulses, reshaping the resulting electrical signal, and modulating it onto a new optical carrier, but it is clearly preferable if practicable to regenerate in the “optical layer”, that is without conversion to an electrical signal.

It is known that if an optical pulse passes through a length of non-linear optical fiber, it will be broadened in the wavelength domain, primarily by an effect called self-phase modulation, meaning that the signal is phase-modulated by passage though a material whose optical properties (specifically its refractive index) are modified by the presence of the signal itself. It is also known that broadening in the wavelength domain varies with intensity in such a way that weak pulses are less broadened than strong ones and, once the pulse is strong enough the intensity at some wavelength displacements from the center of the input pulse varies relatively little with the further increase in the intensity of the input pulse.

Proposals have been made to exploit this effect for the purpose of regeneration of signals in optical return-to-zero format, by amplifying an input signal (for example by an erbium-doped fiber amplifier, a Raman amplifier or a semiconductor optical amplifier), spectrally broadening the pulse by passage through a sufficiently non-linear fiber, and then with a narrow-band filter selecting a portion of the pulse centered on a wavelength suitably displaced from that of the input signal.

A difficulty with this concept is that if, as will normally be the case, an unchanged signal wavelength is desired, a two-stage process requiring twice the component count, cost and volume is needed, and this is compounded by the fact that a practical wavelength-division multiplexed signal cannot be processed as a whole because the changed wavelength would be too close to the next channel wavelength and has to be separated into single channels, or at least subgroups of channels that are more widely spaced.

### SUMMARY OF THE INVENTION

The present invention provides a technique utilizing this principle but requiring fewer components with advantages in compactness, cost and reliability.

One aspect of the invention is a method of regenerating an optical return-to-zero format pulse signal of a first wavelength comprising introducing said signal into a first end of a non-linear optical fiber whereby a modified signal comprising pulses broadened in the wavelength domain emerges from the second end of said non-linear optical fiber; selecting from said modified signal a bandwidth slice centered on a second wavelength so spaced from the first wavelength that its intensity is substantially unresponsive to weak pulses in said signal below an intensity threshold and relatively insensitive to intensity for pulses above said intensity threshold and returning said slice to the same said non-linear optical fiber at its second end whereby a further modified signal comprising pulses broadened in the wavelength domain emerges from said first end of said non-linear optical fiber; and selecting from said further modified signal as regenerated output a bandwidth slice centered on said first wavelength.

In another aspect, the present invention includes a regenerator for an optical return-to-zero format pulse signal of a first wavelength comprising a non-linear optical fiber having a first end and a second end and coupled for introducing said signal into its said first end to cause a modified signal comprising pulses broadened in the wavelength domain to emerge from its said second end; a first filter for selecting from said modified signal a bandwidth slice centered on a second wavelength so spaced from the first wavelength that its intensity is substantially unresponsive to weak pulses in said signal below an intensity threshold and relatively insensitive to intensity for pulses above said intensity threshold coupled for returning said slice to the same said non-linear optical fiber at its said second end to cause a further modified signal comprising pulses broadened in the wavelength domain to emerge from said first end of said non-linear optical fiber; and a second filter for selecting from said further modified signal as regenerated output a bandwidth slice centered on said first wavelength.

As with other regenerator types, it is usually desirable for the signal to be amplified immediately before any other regeneration step and it may be further amplified at any other convenient stage (including, in particular, at the second end of the non-linear fiber or in the non-linear fiber itself).

Each of the first and second filters may be either a reflection filter or a band-pass filter, if and as appropriate used with standard optical connecting components such as splitter-couplers, fiber loops and optical circulators. Bragg grating filters are considered especially suitable.

For use with wavelength-division multiplexed signals, a demultiplexer will almost always need to be used at the input to the apparatus to separate individual channels, or preferably groups of channels of relatively wide spacing, to avoid interference between neighboring channels in the regeneration process; the same component may also serve as a multiplexer to interleave the regenerated signals.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention and together with the description serve to explain the principles and operations of the invention.

### BRIEF DESCRIPTION OF THE DRAWINGS

FIG. 1 is a diagram of one embodiment of the present invention; and

Each of FIGS. 2-7 is a diagram of the distinctive part of a different embodiment of the invention.

### DETAILED DESCRIPTION OF THE PREFERRED EMBODIMENTS

Reference will now be made in detail to the present preferred embodiments of the invention, examples of which are illustrated in the accompanying drawings. Whenever possible, the same reference numerals will be used throughout the drawings to refer to the same or like parts.

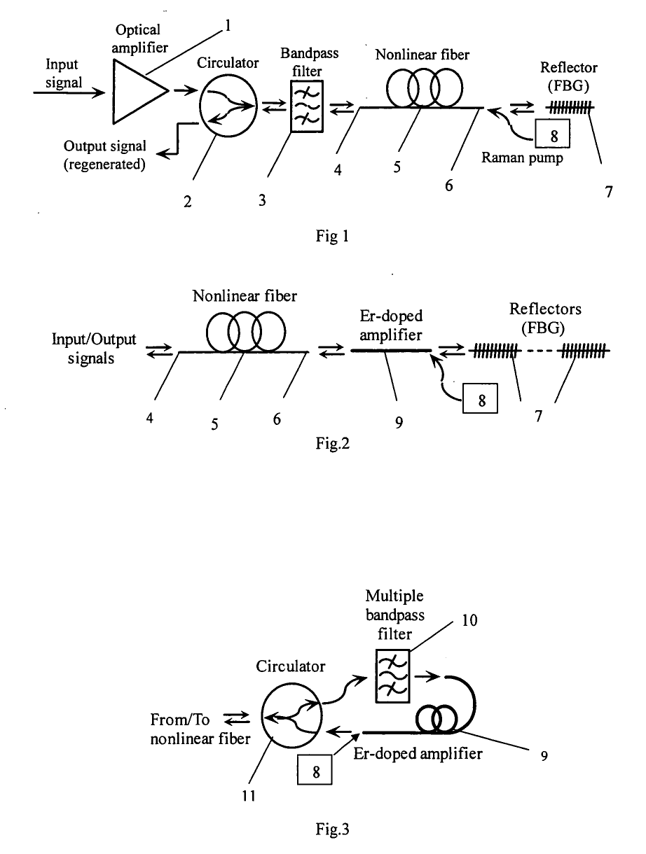

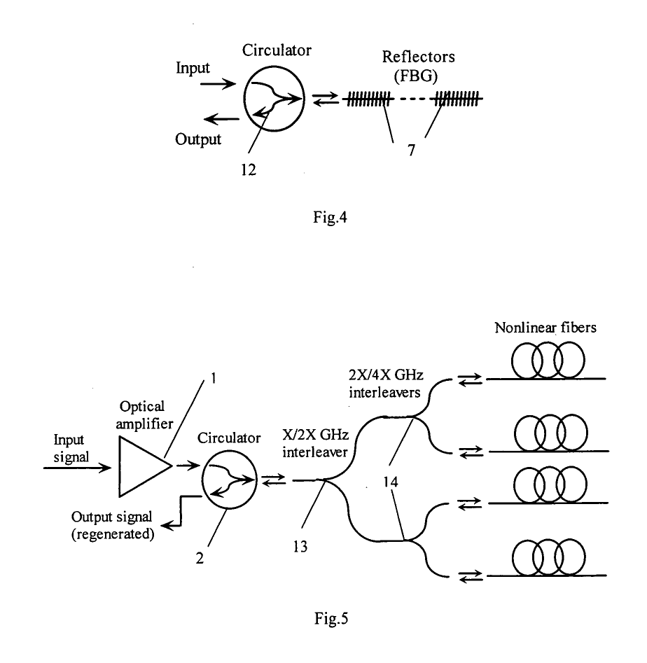

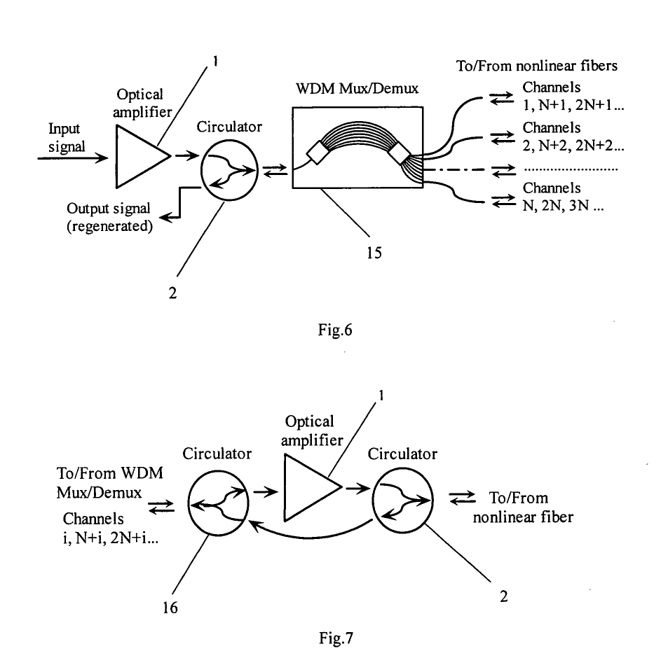

FIG. 1 represents a simple form of the regenerator in accordance with the invention, and thus illustrates the key steps of the method of the invention. An optical input signal in a return-to-zero pulse format at a first wavelength which will be designated λ₁ is first amplified by an optical amplifier 1 (erbium-doped fiber amplifiers, Raman amplifiers and semiconductor optical amplifiers are all suitable) and then passed via a circulator 2 and a bandpass filter 3 tuned to the wavelength λ₁ (whose respective functions will be detailed shortly) to enter the first or left-hand end 4 of a length of highly nonlinear optical fiber 5. Due to self-phase modulation in the fiber, it emerges from the second or right-hand end 6 of the nonlinear fiber with its wavelength spectrum substantially broadened. A fiber Bragg reflector filter 7 is tuned to reflect a wavelength slice centered on a second wavelength λ₂ which is different from λ₁ but within the broadened spectrum and having substantially the same spectral bandwidth as the original signal had (the difference may be such that λ₁ is either outside or within the reflected bandwidth). In a single-wavelength regenerator, it is immaterial whether λ₁ is higher or lower than λ₂; it is the absolute difference |λ₂−λ₁| that is significant. In a multiplexed system, there may be a risk of interference between adjacent channels, and it will normally be desirable for the sign of λ₂−λ₁ to be the same for each channel. The optimum values of λ₂ and of the bandwidth of the slice can be determined by simple trial and error experiments. As explained above, it is found that weak pulses that might occur as a result of degradation in the time-slot of a 0 (no light) bit and risk causing a bit error (and “eye closure”) will, if the design is numerically satisfactory, not appear in that slice because their wavelength spectrum is not broadened as far as that. For definiteness, such weak pulses may be defined as being pulses with an intensity below a predetermined threshold level. Input pulses with intensities above that threshold level, corresponding to 1 (light on) digits will result in pulses within the bandwidth slice, but their intensities vary much less than the intensities of the input pulses. The result is that a modified signal which is regenerated but at a changed wavelength is returned to the nonlinear fiber 5 at its second (right-hand) end 6.

In its second passage through the nonlinear fiber, the new pulses will in their turn be broadened, and the band-pass filter 3 selects a second wavelength slice, similar in bandwidth to the slice selected by the fiber Bragg grating 7 but centered on the first wavelength λ₁, and thus performs a second step of regeneration in the same way and returns the signal to its original wavelength; the output signal is extracted by the circulator 2 for onward transmission. Optionally a pump laser 8 of appropriate wavelength may be coupled to the non-linear fiber 5, at either end, to provide additional gain by Raman amplification.

The regenerator of FIG. 1 is for use with an single channel signal, but is simply adapted to regenerate a number of channels, provided their wavelengths are far enough apart to avoid nonlinear interaction between them (“cross-phase modulation”): all that is required is to use a multiple band-pass filter as the filter 3 and to provide a fiber Bragg grating reflector 7 for each channel, as illustrated in FIG. 2, which corresponds generally to the right-hand part of FIG. 1. This FIG. 2 also illustrates the use of a separate bidirectional booster amplifier 9, illustrated in the form of an erbium-doped fiber (with its pump laser 8).

FIG. 3 corresponds to the right-hand part of FIG. 2 and illustrates the option of using a bandpass filter 10 (either single-wavelength or multiple, as required) coupled by a circulator 11 instead of a reflection filter. The amplifier 9 (for illustration shown as an erbium-doped fiber amplifier) is optional and may be located on either side of the circulator; to the right (as shown) it functions unidirectionally; if positioned to the left of the circulator, it would act bidirectionally as in FIG. 2. A bidirectional amplifier has disadvantages, depending on its type: in an erbium-doped fiber amplifier, the major risk is that excess noise may be generated by multi-path interference, in Raman amplifiers the fact that one of the propagation directions must co-propagate with the pump radiation gives rise to a risk of pump-signal noise transfer and in semiconductor amplifiers, distortion can come from cross-gain saturation of counter-propagating signals. Consequently, the unidirectional arrangement may be preferred, despite a few additional components.

FIG. 4 illustrates how fiber Bragg grating reflectors can be used to make band-pass filters for use in the apparatus of FIG. 3; the reflectors 7 are simply located in a side-branch coupled by a three-port circulator 12, with the result that reflected wavelengths emerge from the output of the circulator and rejected ones escape at the free end of the side-branch. A similar arrangement can be used as the band-pass filter 3 in FIG. 1, but requires a four-port circulator and a separate reflecting side-branch for the respective directions of propagation. Compared with band-pass filters of the Fabry-Perot and Mach-Zehnder types and arrayed waveguide grating routers (AWG) (either of which can be used in the invention), fiber Bragg grating reflecting filters have the advantages that they are easily designed for very high reflectance in a clearly defined band of chosen center and width, and more especially multiples of such bands and that they can be designed with chromatic dispersion to compensate or otherwise manipulate the chirp of the signal pulses.

As already explained, channels in practical wavelength-division multiplexed systems are spaced too closely together to be regenerated in a single fiber (for example, typical channel spacing for 40 Gb/s system is 100 GHz). Spectral broadening by self-phase modulation would cause the spectra of neighboring channels to have a significant overlap and to interfere because cross-phase modulation would cause cross-talk between the channels. In the 40 Gb/s example, even for channel spacing of 200 GHz inter-channel cross-phase modulation crosstalk would still be too strong. Therefore, it can be expected that for effective regeneration channels should be split into several subsets, each of them having spectral channel separation of about 400 GHz or larger. Those subsets could then be regenerated independently, each in its own nonlinear fiber. An important advantage of the present invention is that the same optical device that is used to split the channels can also serve to re-combine them after regeneration, and may also perform a spectral filtering function for the second regeneration stage. This results in further reduction of the overall device cost and package size.

In practice, the device splitting the channels into four individual subsets can be constructed from three commercially available elements known as channel interleavers. FIG. 5 illustrates this, taking again an example of 40 Gb/s system with 100 GHz channel spacing, first interleaver 13 is designed to separate even and odd channels (100/200 GHz interleaver in the example), forming two channel subsets with 200 GHz spectral spacing. Two more interleavers 14, 14 (200/400 GHz design) further split channels into four subsets each having 400 GHz spacing. For the light returning back from nonlinear fibers, in addition to re-combining all channels back in one fiber, this combination of interleavers will serve as a periodic bandpass filter with 400 GHz periodicity. For current standard commercial interleavers the individual passband width will be approximately 100 GHz. Custom interleavers with smaller passband width can be relatively easily designed, if required.

If even larger channel separation and, therefore, number of channel subsets larger than four is required, cascaded interleavers can be replaced, as shown in FIG. 6 by a channel multiplexer/demultiplexer. Such devices, based on arrayed waveguide gratings, diffraction gratings or multi-pass thin-film filters are also commercially available and can be designed to separate any number of channels from four up to 80. A property important for the present application that almost all of these devices have is spectral periodicity. For example, a 6-channel demultiplexer will separate multiplex channels numbers 1 through 6 and send each one on a separate output fiber. Due to spectral periodicity, channel number 7 may be output on the same fiber as channel 1, and then channel 8 will be output on the same fiber as channel 2 and so on, as shown in FIG. 6. Therefore, a single 6-channel demultiplexer will split system channels into 6 subsets. Similarly to cascaded interleavers, it will also serve to re-multiplex the channels and perform spectral filtering after the second pass through the nonlinear fiber. Again, periodic spectral passband width can be designed to have any value equal to or smaller than the original channel separation.

In the regenerator front-end designs presented in FIGS. 5 and 6, a single optical amplifier is used to amplify all of the channels. Given sometimes large channel count of modern wavelength-division multiplex systems, additional loss in the circulator and multiplexer and relatively large power required to produce the required degree of self-phase modulation for spectral broadening, this can translate into an unreasonably high output power required from the amplifier. Alternatively, the channels can be split prior to the amplification, and a separate optical amplifier supplied for each channel subset. If, as preferred, the amplifier is unidirectional, a circulator for each channel subset and one additional wavelength-division multiplexer identical or similar to the input demultiplexer will be needed to re-multiplex channel subsets upon exiting from their respective circulators. If cost-effective, additional circulators 16 can be used to by-pass amplifiers and return channel subsets to the respective fibers that originally carried them, as shown in FIG. 7.

The designs for various regenerator parts presented in FIGS. 2 through 7 can be used in any combination to build a complete device.

One simple specific example of a regenerator in accordance with the present invention may be constructed according to FIG. 1 as modified for use with multiplexed optical signals according to FIG. 5 and, with the parameters indicated, will regenerate a 40 Gb/s 33% duty cycle RZ format four-channel signal as detailed in the table that follows. The channel spacing is assumed to be 4.8 nm (corresponding to 600 GHz) and the bandwidth of each incoming channel (at 3 dB) to be 0.6 nm; the bandwidth of each of the filters is also about 0.6 nm, centered at the wavelength indicated, and for each channel λ₂=λ₁+0.40 nm.

| | incoming cen- | center wavelength of | center wavelength of |
|---|---|---|---|
| channel | ter wavelength | respective reflector | respective bandpass |
| number | (λ₁, nm) | filter 7 (λ₂, nm) | filter 3 (=λ₁, nm) |
| 1 | 1552.52 | 1552.92 | 1552.52 |
| 2 | 1557.36 | 1557.76 | 1557.36 |
| 3 | 1547.72 | 1548.12 | 1547.72 |
| 4 | 1542.94 | 1543.34 | 1542.94 |

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

Any discussion of the background to the invention herein is included to explain the context of the invention. Where any document or information is referred to as “known ”, it is admitted only that it was known to at least one member of the public somewhere prior to the date of this application. Unless the content of the reference otherwise clearly indicates, no admission is made that such knowledge was expressed in a printed publication, nor that it was available to the public or to experts in the art to which the invention relates in the US or in any particular country (whether a member-state of the PCT or not), nor that it was known or disclosed before the invention was made or prior to any claimed date. Further, no admission is made that any document or information forms part of the common general knowledge of the art either on a world-wide basis or in any country and it is not believed that any of it does so.

1. A method of regenerating an optical return-to-zero format pulse signal of a first wavelength comprising introducing said signal into a first end of a non-linear optical fiber whereby a modified signal comprising pulses broadened in the wavelength domain emerges from the second end of said non-linear optical fiber; selecting from said modified signal a bandwidth slice centered on a second wavelength so spaced from the first wavelength that its intensity is substantially unresponsive to weak pulses in said signal below an intensity threshold and relatively insensitive to intensity for pulses above said intensity threshold and returning said slice to the same said non-linear optical fiber at its second end whereby a further modified signal comprising pulses broadened in the wavelength domain emerges from said first end of said non-linear optical fiber; and selecting from said further modified signal as regenerated output a bandwidth slice centered on said first wavelength.

2. A method as claimed in claim 1 comprising amplifying said signal immediately before introducing it into said first end.

3 A method as claimed in claim 2 comprising further amplifying said signal at said second end of the non-linear fiber.

4 A method as claimed in claim 2 comprising further amplifying said signal in said non-linear fiber itself.

5 A method as claimed in claim 1 of regenerating wavelength-division multiplexed optical signals comprising separating subsets of wavelengths having spacings greater than those of the input signal, regenerating each subset as aforesaid, and interleaving the regenerated subsets.

6 A method as claimed in claim 5 comprising amplifying each said subset.

7 A regenerator for an optical return-to-zero format pulse signal of a first wavelength comprising a non-linear optical fiber having a first end and a second end and coupled for introducing said signal into its said first end to cause a modified signal comprising pulses broadened in the wavelength domain to emerge from its said second end; a first filter for selecting from said modified signal a bandwidth slice centered on a second wavelength so spaced from the first wavelength that its intensity is substantially unresponsive to weak pulses in said signal below an intensity threshold and relatively insensitive to intensity for pulses above said intensity threshold coupled for returning said slice to the same said non-linear optical fiber at its said second end to cause a further modified signal comprising pulses broadened in the wavelength domain to emerge from said first end of said non-linear optical fiber; and a second filter for selecting from said further modified signal as regenerated output a bandwidth slice centered on said first wavelength.

8 A regenerator as claimed in claim 7 further comprising an amplifier immediately upstream of said first end.

9 A regenerator as claimed in claim 8 comprising a further amplifier.

10 A regenerator as claimed in claim 9 in which said further amplifier is located at said second end of the non-linear fiber.

11 A regenerator as claimed in claim 9 in which said further amplifier comprises said non-linear fiber itself.

12 A regenerator as claimed in claim 7 in which at least one of said first and second filters is a reflection filter.

13 A regenerator as claimed in claim 12 in which said reflection filter is a fiber Bragg grating filter.

14 A regenerator as claimed in claim 7 in which at least one of said first and second filters is a band-pass filter.

15. A regenerator as claimed in claim 7 for use with wavelength-division multiplexed signals, comprising a demultiplexer to separate and subsequently to interleave individual channels to avoid interference between neighboring channels in the regeneration process.

16. A regenerator as claimed in claim 7 for use with wavelength-division multiplexed signals, comprising a demultiplexer to separate and subsequently to interleave groups of channels of relatively wide spacing to avoid interference between neighboring channels in the regeneration process.

17 A regenerator as claimed in claim 16 comprising a respective optical amplifier for each of said groups of channels.

18 A regenerator as claimed in claim 7 in which at least one of said first and second filters has chromatic dispersion and manipulates chirp in said signal.

19 A regenerator as claimed in claim 7 in which at least one of said first and second filters has chromatic dispersion and compensates chirp in said signal.
